(19) United States
(12) Patent Application Publication
(10) Pub. No.: US 2024/0103461 A1
(43) Pub. Date: Mar. 28, 2024

(54) METHOD FOR A MODEL-BASED DETERMINATION FOR PROCESSING AN ORDER INQUIRY

(71) Applicant: Windmöller & Hölscher KG, Lengerich (DE)

(72) Inventors: Martin BACKMANN, Lengerich (DE); Markus BUSSMANN, Lengerich (DE); Melanie SCHUH, Lengerich (DE); Lennart EDERLEH, Lengerich (DE)

(73) Assignee: Windmöller & Hölscher KG, Lengerich (DE)

(21) Appl. No.: 17/768,901

(22) PCT Filed: Oct. 8, 2020
(86) PCT No.: PCT/EP2020/078237

§ 371 Date: Apr. 14, 2022

(30) Foreign Application Priority Data
Oct. 14, 2019 (DE) 10 2019 127 549.0

(51) Int. Cl. G05B 13/04; G05B 13/02

(52) U.S. Cl. CPC G05B 13/042; G05B 13/027

(57) ABSTRACT

The invention relates to a method for a model-based determination for processing an order inquiry (AA) by means of a production model (PM) of a film extrusion line (10), comprising the following steps:
Capture at least one model parameter (MP) in the form of an output parameter (AP) of the production model (MP) to capture a requested film product property of the order inquiry (AA),
Forming a parameter relationship between the detected at least one output parameter (AP) and at least one model parameter (MP) in the form of an input parameter (EP) of the production model (PM) for determining a production situation of the film extrusion line (10),
Generating at least one input parameter (EP) of the production model (PM) based on the formed parameter relationship as a default for a production process on the film extrusion line (10).

The present invention relates to a method for a model-based determination for processing an order inquiry, and to a computer product for executing a method according to the invention.

It is known that order inquiries are received by companies to order film products. The production of these film products based on this order takes place on so-called film extrusion lines. These can be both blown film extrusion lines and flat film extrusion lines. An order inquiry usually includes a film type with a corresponding film quality and the associated production quantity. Previous order requests are usually made manually or purely from an economic point of view.

The disadvantage of the known solutions is that a purely manual and economic approach cannot evaluate the actual production capabilities of one or more film extrusion lines, or can only do so to a very limited extent and essentially only on the basis of experience. This leads to the fact that errors can occur in the utilization of the film extrusion line, the economic evaluation or other parameters, which can significantly reduce the efficiency of production at the contractor. In particular, the efficiency in the operation of the film extrusion line cannot be fully optimized in this way, both in terms of energy and economy.

It is therefore the object of the present invention to at least partially eliminate the disadvantages described above. In particular, it is an object of the present invention to improve, in a cost-effective and simple manner, the processing of an order request for a film extrusion line.

The foregoing problem is solved by a method having the features of claim 1 and a computer program product having the features of claim 10. Further characteristics and details of the invention result from the dependent claims, the description and the drawings. Features and details described in connection with the method according to the invention naturally also apply in connection with the computer program product according to the invention and vice versa in each case, so that reference is or can always be made mutually with regard to the disclosure concerning the individual aspects of the invention.

According to the invention, a method of a model-based determination is used to process an order inquiry by means of a production model of a film extrusion line. Such a method has the following steps:
Acquiring at least one model parameter in the form of an output parameter of the production model for acquiring a requested film product property of the order inquiry,
Forming a parameter relationship between the detected at least one output parameter and at least one model parameter in the form of an input parameter of the production model for determining a production situation of the film extrusion line,
Generating at least one input parameter of the production model based on the formed parameter relationship as a default for a production process on the film extrusion line.

A method according to the invention allows a defined procedure in the processing of an order inquiry using a production model. In this context, a production model is understood to be a model which represents the film extrusion line at least in partial areas and in this way provides parameter relationships between individual model parameters. Such a production model can be designed as a purely algorithmic and/or a purely empirical model. The use of so-called neural networks as artificial intelligence is also possible for the production model. Of course, the variants of the production model described above can also be combined with each other, for example, the combination of an empirical model with a neural network.

The steps according to the invention now make it possible to acquire at least one model parameter pin from an order inquiry in the form of an output parameter. This order inquiry and the correlated model parameter can thus deal with a film product or with the associated film product property. For example, the order inquiry may include a specific quality property, for example, in the form of tearability or stretchability as a film product property. Such an order inquiry is now recorded with this output parameter as a model parameter and can thus be entered into the production model.

In the second process step according to the invention, a parameter relationship is now formed, namely between the detected output parameter and at least one model parameter in the form of an input parameter of the production model. In other words, it is possible that the requested film product property in the form of the output parameter is related to a corresponding production situation of the film extrusion line as input parameter. A qualitative, but also a quantitative parameter relationship is conceivable. Thus, it is basically possible that the parameter relationship affirms or denies the basic manufacturing possibility on the film extrusion line. However, quantitative parameter relationships are also conceivable, for example a relationship between a requested film product property and a correspondingly adjustable production situation, for example the speed, efficiency level or throughput of the film extrusion line. It should also be noted that, of course, not only a single output parameter can be recorded and not only a single input parameter can be set in parameter relationship. In the embodiment of a method according to the invention, in particular a plurality of model parameters is acquired and a plurality of parameter relationships is formed bilaterally, in particular multilaterally.

As a result of the fact that a parameter relationship between the order inquiry and the actual production possibilities can now already be generated before the start of a film production, an input parameter can finally be generated which forms a specification for the production process on the film extrusion line on the basis of this formed parameter relationship. This can involve a wide variety of input parameters. Thus, it is basically conceivable that the input parameter is generated for which the parameter relationship has also been formed with the at least one output parameter. However, another input parameter can also be generated in this last process step.

The production model can thus take into account a wide variety of model parameters. Different submodels can also be taken into account. For example, the production model can be or have a pure machine model and additionally have a combination with an economic model, i.e. the economic mode of operation of the film extrusion line.

By carrying out a process according to the invention, it is now possible to assign an order inquiry to production on a film extrusion line in an at least partially automated or even fully automated manner. In other words, it is now possible, based on an order inquiry, without manual intervention and even without any experience, to generate an input parameter through the parameter relationships of the production model before the production process itself has started. This input parameter can serve as a default for the production process, as will be explained in more detail later.

Thus, there may be advantages if, in a method according to the invention, at least one of the following steps is carried out with the generated at least one input parameter:
Specification of a specific film extrusion line
Specification of process parameters for the operation of the film extrusion line
Specification of machine parameters for the operation of the film extrusion line
Specification of economic data for the operation of the film extrusion line
Specification for a raw material selection for the operation of the film extrusion line
Specification for a raw material composition for the operation of the film extrusion line

The above list is not exhaustive. When specifying a specific film extrusion line, for example, the film extrusion line that can produce the film product with the highest efficiency or with the greatest economic efficiency according to the order inquiry can be selected. It is also possible to preset process parameters in order to be able to start with these process parameters when starting the operation of the film extrusion line. Machine parameters can also be specified to operate this selected film extrusion line in an appropriate manner. Economic data for the operation of the film extrusion line can also be specified, for example, to increase economic efficiency in the production of the requested film product. A raw material selection or a raw material composition can also be specified here by the method according to the invention.

It brings further advantages if, in a method according to the invention, an order response is generated on the basis of the generated at least one input parameter for a response to the order inquiry. Based on the input parameter, such an order response may contain it or further form it. The order response is therefore a response or, in particular, information with regard to content, which is sent in response to the order inquiry. In particular, this will directly or indirectly contain the generated input parameter. In particular, reference is furthermore made to the timing, basic costs, compositions or quality possibilities, which are related to the received order request and can be formed on the basis of the generated input parameter.

It is furthermore advantageous if, in a method according to the invention, a comparison is made with at least one further order inquiry or at least one already existing production order on the basis of the generated at least one input parameter, a sequence of at least two production orders being created on the basis of the result of the comparison. In other words, production orders can be modified and adjusted in terms of their chronological sequence. Common or similar requirements on a film extrusion line can thus be bundled, so that the costs for the inquirer of the order request as well as for the operator of the film extrusion line can be significantly reduced and thus the efficiency in operation can be increased. In other words, it becomes possible to perform a corresponding optimization not only within a single order on the film extrusion line, but rather over several neighboring and temporally adjacent orders.

It can be a further advantage if, in a process according to the invention, the parameter relationship is formed to the same input parameter which is subsequently generated. In other words, direct influence becomes possible here. Alternatively or in addition to this, especially when generating several input parameters, however, indirect influence is also conceivable.

Further advantages may be gained if, in a method according to the invention, at least one optimization step is performed during the generation of the at least one input parameter, in particular with at least one of the following priorities:
Reduction of production numbers
Reduction of raw material requirements
Increase in line efficiency
Reduction of the energy demand
Reduction of scrap production
Reduction of downtime of the film extrusion line

The above list is not exhaustive. Of course, two or more priorities can be provided to perform the optimization. In particular, the production model can be used to perform an iterative simulation to achieve the corresponding optimization goal. Of course, partial modifications to the request are also conceivable in order to send an appropriately adjusted order offer in response to the order request. For example, it can be pointed out that a significant cost reduction can be achieved with minor deviations in quality, for example with thicker film. This ensures that not only is order processing significantly improved, but there are also further advantages and optimization possibilities for the operator of the film extrusion line as well as for the customer.

It can also be advantageous if, in a method according to the invention, historical data on production orders that have already been completed are taken into account when forming the parameter relationship. In particular, this applies to orders from the same customer or orders with identical production content. For example, agreed prices, agreed quantities or the like can be included in the production model as additional economic data, especially as historical economic data. Such historical information from already completed production orders can also be introduced for the further development of the production model to ensure further training as a self-learning production model.

It is also advantageous if, in a method according to the invention, an adjustment of the production model takes place on the basis of a production success during and/or after the completion of a production order on the basis of an associated order inquiry. Thus, after completion or during the completion of a production order, it can be checked whether the prediction based on the production model is correct or deviates from reality. Both the accuracy and the deviation can be introduced as feedback into the production model and further develop it. The production model is thus designed as a self-learning model. In particular, this applies to the combination of relevant data, for example with regard to raw material prices, raw material selection and/or the energy requirement in the production of the production order.

There may also be advantages if a weighted neural network is used as the production model in a method according to the invention. This can of course also be combined with empirical models and/or with algorithmic models. Training with orders that have already been completed and executed is also conceivable here, in order to train the artificial intelligence on the corresponding film extrusion line, in particular using a so-called deep learning process.

Another object of the present invention is a computer program product having instructions which, when the program is executed on a computer, cause the computer to perform the steps of a determination procedure according to the invention. Thus, a computer program product according to the invention brings the same advantages as have been explained in detail with reference to a method according to the invention.

Further advantages, features and details of the invention are given in the following description, in which, with reference to the drawings, embodiments of the invention are described in detail. The features mentioned in the claims and in the description may be individually or in any combination substantially inventive.

The accompanying drawings are schematic representations, in which:

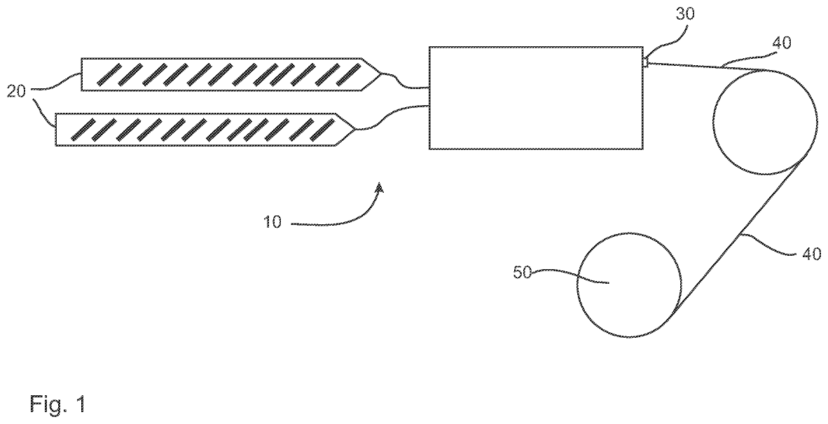

FIG. 1 shows an embodiment of a film extrusion line,

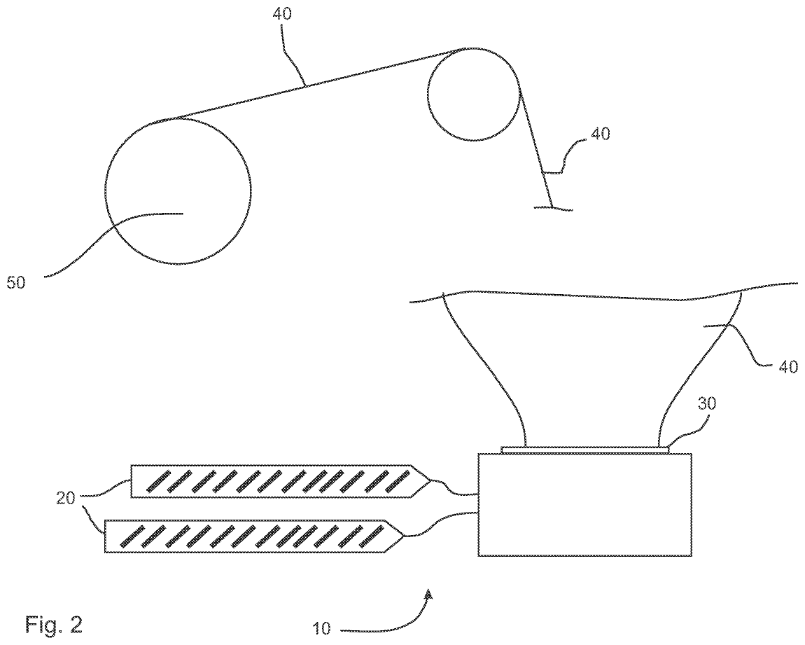

FIG. 2 shows another embodiment of a film extrusion line,

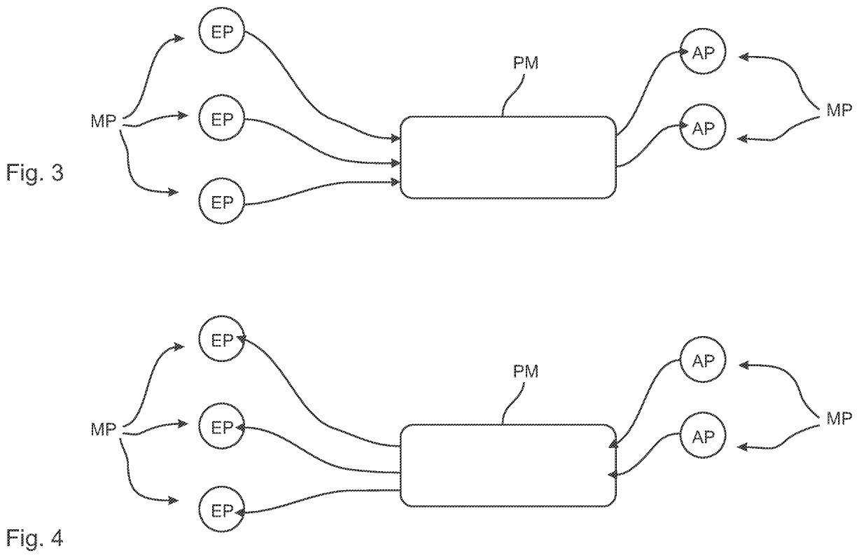

FIG. 3 shows an embodiment of the use of the production model

FIG. 4 shows an embodiment of the use of the production model,

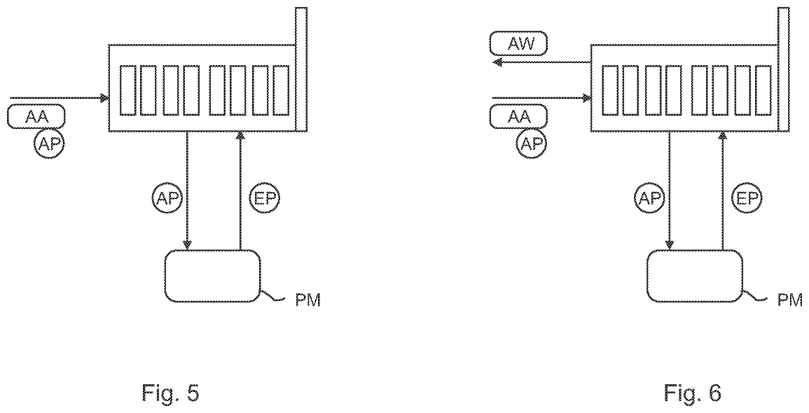

FIG. 5 shows an example of an order request,

FIG. 6 shows another example of an order request,

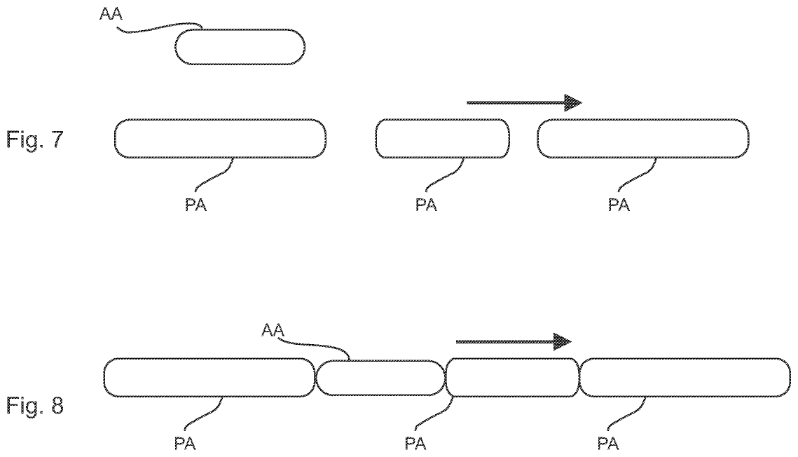

FIG. 7 shows a first step in incorporating the order request into a production flow, and

FIG. 8 shows the result of the integration according to FIG. 7.

FIG. 1 schematically shows a film extrusion line 10. This example is a flat film line with two extruders 20, which discharge extrusion material through a die 30. The flat film produced is wound as a film sheet 40 over a chill roll on a winding reel 50. Alternatively, it is also possible if the film extrusion line 10 shown in FIG. 2 is a blown film extrusion line. Here, too, a combination of two extruders 20 is shown schematically, which form a blown film as a film sheet 40 via an annular die 30. This is laid flat and rolled up over a deflection roller as a film web 40, also on a winding roller 50.

FIGS. 3 and 4 show schematically in which way a production model PM can now set or set parameter relations. Model parameters MP of production model PM here can be input parameters EP and output parameters AP. FIGS. 3 and 4 differ in the direction in which the production model PM acts. In principle, a bidirectional or even multidirectional effect is possible. Thus, it is conceivable that input parameters EP are generated from output parameters AP via the production model, but also in the opposite direction.

The core idea of the invention is shown schematically in particular in FIG. 5. In an industrial process or plant, an order inquiry AA is received. This receives the information about at least one output parameter AP. Within the industrial line, a production model PM, for example as a computer program product, is stored and available. The at least one output parameter AP of the order inquiry AA is now set in parameter relationship with at least one input parameter EP using the production model PM, such that an identical or different input parameter EP is subsequently generated as an output from the production model PM. Based on these generated input parameters EP, a variety of options can now be generated, for example, the optimization of the film production process, an appropriate selection of a film extrusion line or even an optimization of the requested production order.

FIG. 6 shows a further development of the embodiment in FIG. 5. Here, based on the generated input parameter EP, an order response is generated, which may contain, for example, the input parameter EP that has been generated. The forwarding and feedback to the corresponding requester means that the order inquiry AA can now be answered and released for production, for example.

FIGS. 7 and 8 clearly show how optimization can also be carried out beyond individual production orders PA with the aid of a process according to the invention. An order inquiry AA can now be precisely defined with the help of a production model PM not only economically and energetically, but also in terms of time. In order to provide for an integration into a time sequence of several production orders PA, similar, for example based on similar raw materials, production orders PA can now be combined with each other. It is also possible to combine the times so that, in particular, the dead times of the film extrusion line can be reduced, as can be seen, for example, in FIG. 8 by fitting the order inquiry AA into the time sequence of the production orders PA.

The foregoing explanation of embodiments describes the present invention by way of example only. Of course, individual features of the embodiments can be freely combined with each other, if technically reasonable, without leaving the scope of the present invention.

### REFERENCE SIGN LIST

10 Film extrusion line
20 Extruder
30 Nozzle
40 Film sheet
50 Winding roll
PM Production model
MP Model parameter
EP Input parameter
AP Output parameters
AA Order inquiry
AW Order response
PA Production order

1-10. (canceled)

11. A method for a model-based determination for processing an order inquiry by means of a production model of a film extrusion line, comprising the following steps:
Capture at least one model parameter in the form of an output parameter of the production model to capture a requested film product property of the order inquiry,
Forming a parameter relationship between the detected at least one output parameter and at least one model parameter in the form of an input parameter of the production model for determining a production situation of the film extrusion line,
Generating at least one input parameter of the production model based on the formed parameter relationship as a default for a production process on the film extrusion line.

12. The method according to claim 11, wherein at least one of the following steps is carried out with the generated at least one input parameter:
Specification of a specific film extrusion line
Specification of process parameters for the operation of the film extrusion line
Specification of machine parameters for the operation of the film extrusion line
Specification of economic data for the operation of the film extrusion line
Specification for a raw material selection for the operation of the film extrusion line
Specification for a raw material composition for the operation of the film extrusion line.

13. The method according to claim 11, wherein an order response is generated on the basis of the generated at least one input parameter for a response to the order inquiry.

14. The method according to claim 11, wherein on the basis of the generated at least one input parameter, a comparison is made with at least one of at least one further order inquiry or at least one already existing production order, a sequence of at least two production orders being created on the basis of the result of the comparison.

15. The method according to claim 11, wherein the parameter relationship is formed to the same input parameter which is subsequently generated.

16. The method according to claim 11, wherein during the generation of the at least one input parameter at least one optimization step is performed.

17. The method according to claim 11, wherein historical data on already completed production orders is taken into account when forming the parameter relationship.

18. The method according to claim 11, wherein an adjustment of the production model is carried out on the basis of a production success at least during or after the completion of a production order on the basis of an associated order inquiry.

19. The method according to claim 11, wherein a weighted neural network is used as production model.

20. The method according to claim 16, wherein during the generation of the at least one input parameter at least one optimization step is performed with at least one of the following priorities:
Reduction of the production time
Reduction of raw material requirements
Increase in line efficiency
Reduction of the energy demand
Reduction of scrap production
Reduction of downtime of the film extrusion line.

21. A computer program product comprising instructions which, when the program is executed on a computer, cause the computer to perform the steps of a method having the features of claim 11.
